(19) United States
(12) Patent Application Publication
(10) Pub. No.: US 2026/0202028 A1
(43) Pub. Date: Jul. 16, 2026

(54) LIGHT MODULE FOR A MOTOR VEHICLE

(71) Applicant: HELLA GMBH & CO. KGAA, Lippstadt (DE)

(72) Inventors: Mathias Drüppel, Lippstadt (DE); Bernd Fischer, Altenbeken (DE); Julian Grote, Borchen (DE); Lukas Hiller, Lippstadt (DE); Marc Kaup, Paderborn (DE); Dirk Kliebisch, Paderborn (DE); Susanne Köhler, Lippstadt (DE); Martin Mügge, Geseke (DE); Christian Schmidt, Paderborn (DE); David Schulz, Dortmund (DE)

(21) Appl. No.: 19/448,345

(22) Filed: Jan. 14, 2026

(30) Foreign Application Priority Data
Jan. 15, 2025 (DE) 102025131124.2

(51) Int. Cl. F21S 41/26; F21S 41/143; F21W 102/13

(52) U.S. Cl. CPC F21S 41/26; F21S 41/143; F21W 2102/13

(57) ABSTRACT

A lighting device for a motor vehicle is provided. The lighting device includes a main light module, a signal light modoule, and an additional optical component. The main light module has a first light source, primary optics, and secondary optics. The signal light module includes a second light source, a flat light guide, and an optical component. Light emanating from the second light source passes at least partially through the optical component and/or is reflected by the optical component. The additional optical component includes an optical disk or an optical film and has an entry surface and an exit surface. A structure is provided on the entry surface or on the exit surface of the additional optical component. During operation of the lighting device, light generated by the main light module and light generated by the signal light module passes through the additional optical component.

### CROSS-REFERENCE TO RELATED APPLICATIONS

This application claims the benefit of German Patent Application 10-2025-131-124.2, filed Jan. 15, 2025, the disclosure of which is incorporated by reference in its entirety.

### FIELD OF THE INVENTION

The present invention relates to a lighting device for a motor vehicle.

### BACKGROUND OF THE INVENTION

A lighting device designed as a headlight for a motor vehicle is known from DE 10-2021-122-953 B 3. The lighting device described therein comprises a plurality of light sources from which light is emanating during operation of the lighting device, collimating optics having a plurality of collimating lenses each having an entrance surface and an exit surface through which the light emanating from the light sources passes, and secondary optics having a plurality of arrays of cylindrical lenses, wherein the light emanating from the collimating optics passes through the arrays of cylindrical lenses, wherein the collimating lenses are arranged in at least two rows, wherein in each of the rows at least two of the collimating lenses are arranged side by side in a first direction and wherein the rows are arranged side by side in a second direction, preferably perpendicular to the first direction. The three rows arranged one above the other disclosed in DE 10-2021-122-953 B3 can be used to generate a high beam, an apron component of a low beam and a range component of a low beam as different main light functions.

Design has long been a determining factor for the signaling functions of a motor vehicle, such as a tail light, a brake light, a direction indicator or a daytime running light, in rear lights or headlights. The design of these lighting devices has become even more significant since the introduction of LED technology because the small light-emitting diodes, which are often used in larger numbers, can be used much more flexibly than a large incandescent lamp as a light source for a signal function, so that a wide variety of design options are available in conjunction with the selected optical system.

A variation of LED technology is found in the form of OLED technology, in which the light source is not small and point-like like a light-emitting diode, but rather designed to be flat and larger to form a desired light-emitting surface that can be illuminated very homogeneously. A disadvantage of OLED technology is the significantly higher cost of OLED technology compared to LED technology. The reasons for these high costs are a complex manufacturing process, the different shapes dictated by the design and small quantities. In addition, there are special, high requirements in the automotive sector, such as resistance to UV exposure and the effects of forces such as vibrations, shocks and shaking, as well as temperature resistance in a range between −40° C. and +85° C. or +100° C. These requirements are substantially more difficult to meet for an organic light-emitting diode than for standard light-emitting diodes.

As a result, alternative options are being sought to achieve a design similar to that of organic light-emitting diodes (OLEDs), in particular a homogeneously illuminated surface. This is achieved by using light-emitting diodes (LEDs) with a flat light guide and upstream optics in the form of microstructured films or thin optical disks to scatter the light emitted from the light guide. Overall, this provides a flat light module that offers high performance with homogeneous illumination of the entire surface.

Just as with organic light-emitting diodes, several flat light modules can then be positioned offset next to and behind one another when integrated into a rear light in order to create the desired individual appearance of the signal function, for example the tail light or tail/stop light.

A lighting device of the type mentioned at the beginning, designed as a flat light module, is known from DE 10-2021-122-264 A1. The lighting device described therein comprises a plurality of light sources designed as light-emitting diodes (LEDs) and a flat light guide with an entry surface and at least one exit surface, wherein the entry surface is designed as the end face of the light guide. The lighting device further comprises two optical disks, each provided with at least one structuring, through which the light emanating from the exit surface passes in succession. The structuring of the second optical disk in the direction of propagation of the light is formed by an array of roof prisms, which are arranged next to one another in a first direction and extend parallel to one another in a second direction perpendicular to the first direction. Each of the roof prisms has two inclined flanks, the ends of which form a connecting edge extending in the second direction, wherein the flanks form a roof angle of 90° with one another in the connecting edge.

An exemplary lighting device designed as a flat-light module according to this prior art is shown in FIG. 10 and FIG. 11. This flat light module comprises a light source 1 that has several light-emitting diodes (LEDs). The flat light module further comprises a housing 2 with a front and a rear housing part 2a, 2b, which are connected to one another by a latching mechanism. A plate-shaped light guide 3 with micro-optics, a white, diffusely reflective film 4 behind the light guide 3 and two or three optical components 5a, 5b designed as micro-optics films in front of the light guide 3 are inserted between the housing parts 2a, 2b, which together are responsible for the light distribution and efficiency of the system by coordinating the individual micro-optics components. The principle of this basic structure is to provide a light element with a uniform, homogeneously illuminated surface. For this purpose, the lighting device comprises a cover disk 6, which serves as the illuminated exit surface of the lighting device.

The optical component 5a adjacent to the light guide 3 is designed as a diffuser, whereas the second optical component 5b is designed as so-called BEF optics. BEF in this context means “Brightness Enhancement Film”. The BEF optics therefore serve to increase the brightness of the light passing through the optical component 5b. The BEF optics can be realized on a film or as a thin injection-molded optical disk. Systems with two BEF optics, oriented orthogonally to one another, can also be provided, wherein the diffuser optics are sometimes omitted.

Current main light functions such as low beam and/or high beam are mostly fixed module configurations that can only be changed marginally. With large visible optics with predetermined curvatures and reflections of the outside world. In addition, these modules must be adjusted in height, laterally and usually in relation to one another. This movement is difficult to reconcile with current design trends.

As signal light functions are much more flexible in their design, modules for main light functions such as a low beam and/or a high beam are often located in a different, separate area in a lighting device with main light functions and signal light functions and are often hidden. In most situations, the flexibly configurable area of the signal light functions will therefore be in the foreground. However, as soon as the road is shaded or it is dark, the main light functions must be used. The resulting warm appearance deviates strongly and disruptively from the original design idea. For this reason, it is desirable to match the daytime appearance and the nighttime appearance of a lighting device with main light functions and signal light functions. There are various approaches behind the idea of the same daytime and nighttime appearance. Ideally, a non-different, 100% identical daytime and nighttime appearance, but primarily the desire for integration options for main lighting functions.

### SUMMARY OF THE INVENTION

The problem underlying the present invention is therefore the creation of a lighting device of the type mentioned at the beginning, which can generate at least one main light function and at least one signal light function, wherein the daytime appearance and the nighttime appearance are adapted to one another, in particular resemble one another.

According to the invention, this is achieved by a lighting device of the type mentioned at the beginning with the features of the embodiments disclosed herein.

According to one embodiment, the lighting device includes: at least one main light module for generating at least part of a low beam and/or a high beam, wherein the at least one main light module has at least one light source, primary optics and secondary optics, wherein the at least one main light module is arranged so that the light emanating from the at least one light source passes through the primary optics and through the secondary optics; at least one signal light module for generating at least one signal light function, wherein the at least one signal light module has at least one light source, a flat light guide with an entry surface and at least one exit surface and at least one optical component, wherein the at least one optical component is designed as an optical disk or as an optical film, wherein the at least one signal light module is set up so that the light emanating from the at least one light source enters the entry surface of the flat light guide, emerges from the at least one exit surface of the flat light guide and passes at least partially through the at least one optical component and/or is reflected by the at least one optical component; and an additional optical component, which is designed as an optical disk or as an optical film and has an entry surface and an exit surface, wherein a structure is provided on the entry surface and/or on the exit surface of the additional optical component, and wherein the additional optical component is arranged in the lighting device in such a manner that, during operation of the lighting device, the light generated by the at least one main light module and the light generated by the at least one signal light module passes through the additional optical component.

The at least partially structured additional optical component allows the daytime appearance of the lighting device to be matched to the nighttime appearance, because both the light of at least one main lighting function and the light of at least one signal function passes through the structured additional optical component. In particular, the structured additional optical component forms continuous, seamless decoupling optics. Furthermore, the structured additional optical component serving as decoupling optics prevents adjustment movements of the modules from being visible from the outside.

Furthermore, the structured additional optical component, which serves as decoupling optics, results in a uniform appearance of areas in which main light functions are generated and areas in which signal light functions are generated when the lighting device is switched off. Furthermore, by providing the structured additional optical component, the size, contour, filing and inclination of the decoupling optics can be largely freely selected. In particular, the structured additional optical component serving as the decoupling optics can extend over the entire front of the vehicle. Furthermore, the structured additional optical component serving as decoupling optics provides the possibility of a flexible signature, because individual areas behind the structured additional optical component can be switched on or off. The additional optical component also makes it possible to generate a complete black panel appearance if required.

It may be provided that the structure provided on the entry surface and/or on the exit surface of the additional optical component is strip-shaped, in particular wherein the strip-shaped structure is set up to widen light passing through it in the horizontal direction when the lighting device is installed in the vehicle. For example, the strip-shaped structure of the additional optical component may be formed by cylindrical lenses arranged side by side in a first direction, which corresponds to a horizontal direction when the lighting device is installed in the vehicle, wherein the cylindrical axes of the cylindrical lenses extend in a second direction, which corresponds to the vertical direction when the lighting device is installed in the vehicle. By widening the light passing through the additional optical component in the horizontal direction, the optical component supports the horizontal widening required by the light functions. As a result, a main light module that generates a high beam, no longer requires a component for horizontal expansion, for example.

It is possible for the at least one main light module to have a plurality of light sources and for the primary optics of the at least one main light module to be designed as collimating optics with a plurality of collimating lenses, each of which has an entry surface and an exit surface through which the light emanating from the light sources passes in succession.

It may be provided that the secondary optics of the at least one main light module has a first transparent substrate with an entry surface and an exit surface, wherein a structure is provided on the entry surface and/or on the exit surface of the first substrate which is set up to shape light passing through it in the vertical direction when the lighting device is installed in the vehicle, in particular wherein the first substrate is set up to produce a horizontal cut-off line and/or a gradual vertical light distribution. Thereby, the first transparent substrate of the secondary optics of the at least one main light module may comprise at least one array of irregularly shaped cylindrical lenses, in particular wherein the entry surface of the first substrate comprises a plurality of differently sized entry facets and wherein the exit surface of the first substrate comprises a plurality of equally sized exit facets. This type of design can effectively create a horizontal cut-off line and/or a gradual vertical light distribution.

It may further be provided that the secondary optics of the at least one main light module comprises a second transparent substrate having an entry surface and an exit surface, wherein a stripe-shaped structure is provided on the entry surface and/or on the exit surface of the second substrate, in particular wherein the strip-shaped structure is formed by cylindrical lenses which are arranged next to one another in the first direction, wherein the cylindrical axes of the cylindrical lenses extend in the second direction in order to expand light passing through the strip-shaped structure in the horizontal direction when the lighting device is installed in the vehicle. The second substrate can be provided for a main light module that is used to generate an apron component of a low beam, whereas the second substrate can preferably be omitted in the case of a main light module that is used to generate a main beam distribution, because the additional optical component serving as decoupling optics can achieve sufficient widening in the horizontal direction.

In particular, the signal light module can be designed as a flat light module. It is possible that the at least one signal light module comprises a first and a second optical component, each of which is designed as a microstructured optical film and/or as a microstructured optical disk, wherein the at least one signal light module is set up so that light emerging from the at least one exit surface of the flat light guide passes successively through the first and the second optical component. One of the optical components of the at least one signal light module, in particular the first optical component, can have diffuser optics and/or one of the optical components, in particular the second optical component, can have an array of roof prisms. Diffuser optics can be used to scatter the light appropriately in order to improve the homogeneity of the illumination. The BEF optics can increase the brightness of the light passing through the optical component. Both surfaces or optical components together can ensure efficient illumination of an exit surface such as a cover disk of the lighting device.

It may be provided that the flat light guide of the at least one signal light module has two mutually opposite exit surfaces and that the at least one signal light module has a third optical component which is designed as an at least partially reflective surface which is arranged on the side of the flat light guide facing away from the first two optical components, wherein the lighting device is set up so that light emitted from the exit surface of the light guide facing away from the first two optical components strikes the reflective surface, is reflected back from the latter to the exit surface and at least partially re-enters the light guide before it emerges from the exit surface facing the first two optical components. The effectiveness of the signal light module is increased by the re-entry of the light reflected back from the reflective surface into the light guide.

It is possible that the lighting device is set up so that light emanating from the at least one main light module moves at least partially past the at least one signal light module before it strikes the additional optical component. Alternatively or additionally, it may be provided that the lighting device is set up so that light emanating from the at least one main light module passes at least partially through the at least one signal light module before it strikes the additional optical component. In this case, the at least one optical component of the at least one signal light module can be set up to allow the light emanating from the at least one main light module to pass through substantially unhindered, in particular wherein the at least one optical component of the at least one signal light module has at least one recess and/or at least one unstructured transparent portion to allow the light emitted from the main light module to pass through.

Furthermore, it may be provided that the flat light guide of the at least one signal light module is set up to allow the light emanating from the at least one main light module to pass through substantially unhindered. In this case, the at least one exit surface or at least one of the exit surfaces of the flat light guide of the at least one signal light module can be provided with structuring, in particular wherein the structuring is not provided in at least one portion of the at least one exit surface in order to allow the light emanating from the at least one main light module to pass through.

### BRIEF DESCRIPTION OF THE DRAWINGS

The invention is explained in more detail hereafter with reference to the accompanying drawings. In the drawings:

FIG. 1 is an exploded perspective view of a part of a lighting device according to the invention;

FIG. 2 is a further exploded perspective view of a part of the lighting device according to FIG. 1;

FIG. 3 is a further exploded perspective view of a part of the lighting device according to FIG. 1;

FIG. 4 is a top view of a first main light module of the lighting device according to FIG. 1;

FIG. 5 is a side view of the first main light module as shown in FIG. 4;

FIG. 6 is a top view of a second main light module of the lighting device according to FIG. 1;

FIG. 7 is a side view of the second main light module as shown in FIG. 6;

FIG. 8 is a perspective view of a first substrate of the main light modules of the lighting device according to FIG. 1;

FIG. 9 is a detail of the first substrate according to FIG. 8;

FIG. 10 is a perspective view of a lighting device according to the prior art; and

FIG. 11 is an exploded view of the lighting device shown in FIG. 10.

In the figures, identical or functionally identical parts are indicated with the same reference signs.

### DETAILED DESCRIPTION OF THE CURRENT EMBODIMENT

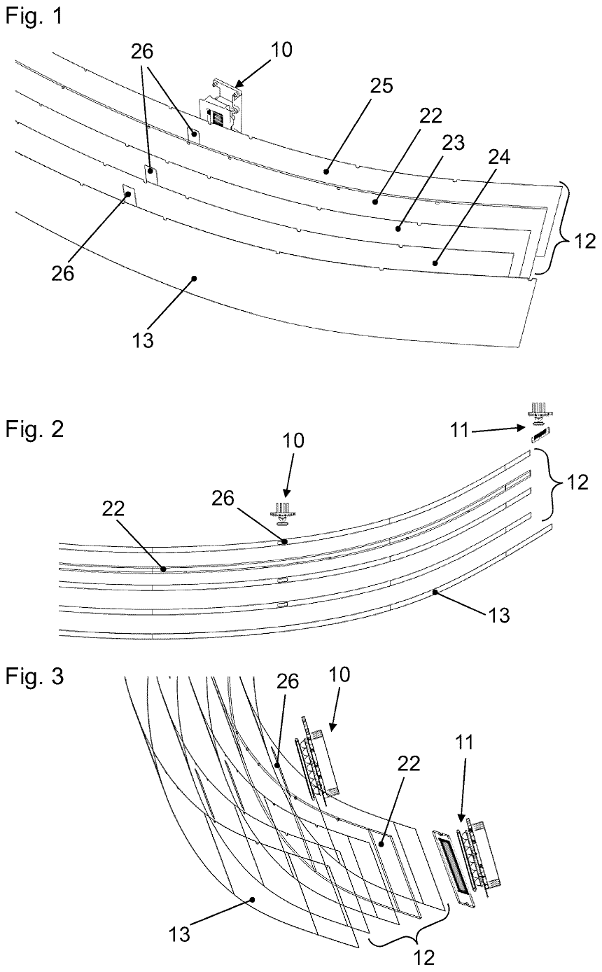

The lighting device shown in FIG. 1 to FIG. 3 comprises at least one first main light module 10 and at least one second main light module 11, at least one signal light module 12 designed as a flat light module and an additional optical component 13, which is designed as an optical disk or an optical film and has an entry surface and an exit surface. The additional optical component 13 is arranged such that, during operation of the lighting device, the light generated by the main light modules 10, 11 and the light generated by the signal light module 12 passes through the additional optical component 13. When installed, the additional optical component 13 extends in the transverse direction of the vehicle, in particular substantially across the entire width of the front of the vehicle.

A strip-shaped structure formed by cylindrical lenses is provided on the entry surface and/or on the exit surface of the additional optical component 13. The cylindrical lenses are arranged side by side in a first direction, which corresponds to a horizontal direction when the lighting device is installed in the vehicle, wherein the cylindrical axes of the cylindrical lenses extend in a second direction, which corresponds to the vertical direction when the lighting device is installed in the vehicle. The strip-shaped structure is set up to expand the light passing through it in a horizontal direction when the lighting device is installed in the vehicle. In particular, the widening caused by the strip-shaped structure can be around ±15°.

FIG. 1 to FIG. 3 only show the two main light modules 10, 11 on the left-hand side of the vehicle. Correspondingly, two additional main light modules 10, 11 are provided on the right side of the vehicle. The second main light module 11 is arranged further outwards on both sides than the first main light module 10.

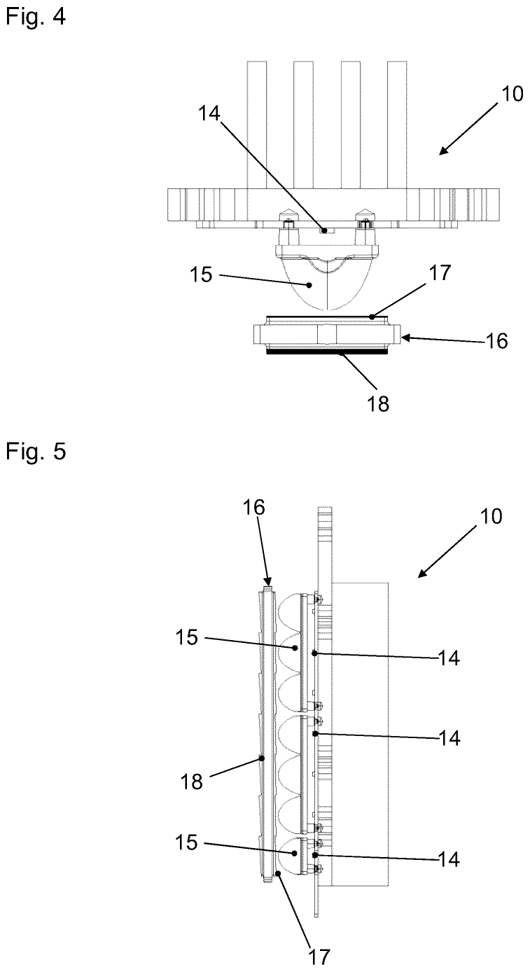

The first main light module 10 is shown in FIG. 4 and FIG. 5. This first main light module 10 is used to generate a high beam. The first main light module 10 comprises a plurality of light sources 14, which are arranged at a distance from one another in the second direction or in the vertical direction and are designed as light-emitting diodes (LEDs) (see FIG. 5). The first main light module 10 further comprises collimating optics serving as primary optics with a plurality of collimating lenses 15, each having an entry surface and an exit surface. The collimating lenses 15 are also arranged at a distance from one another in the second direction or in the vertical direction. Here, one of the collimating lenses 15 is assigned to each of the light sources 14 such that the light emanating from one of the light sources 14 passes successively through the entry surface and the exit surface of the assigned collimating lens 15.

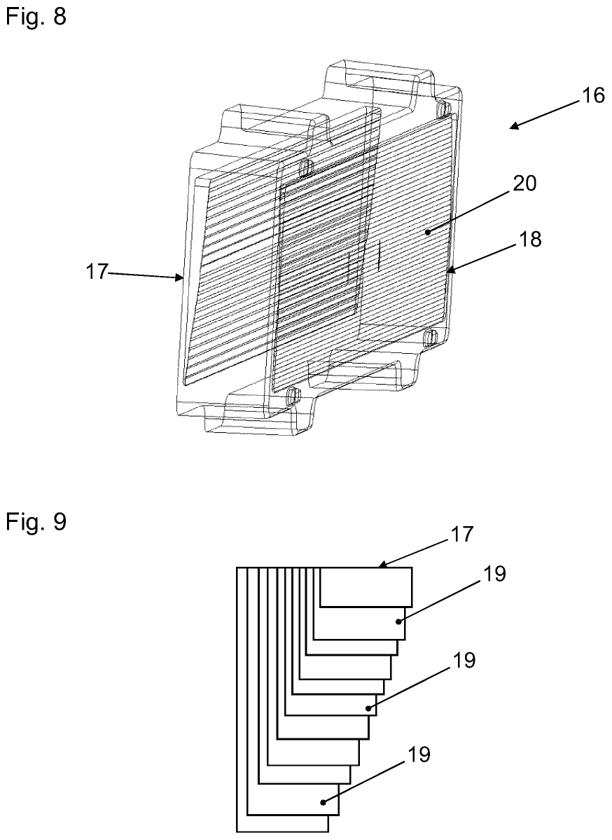

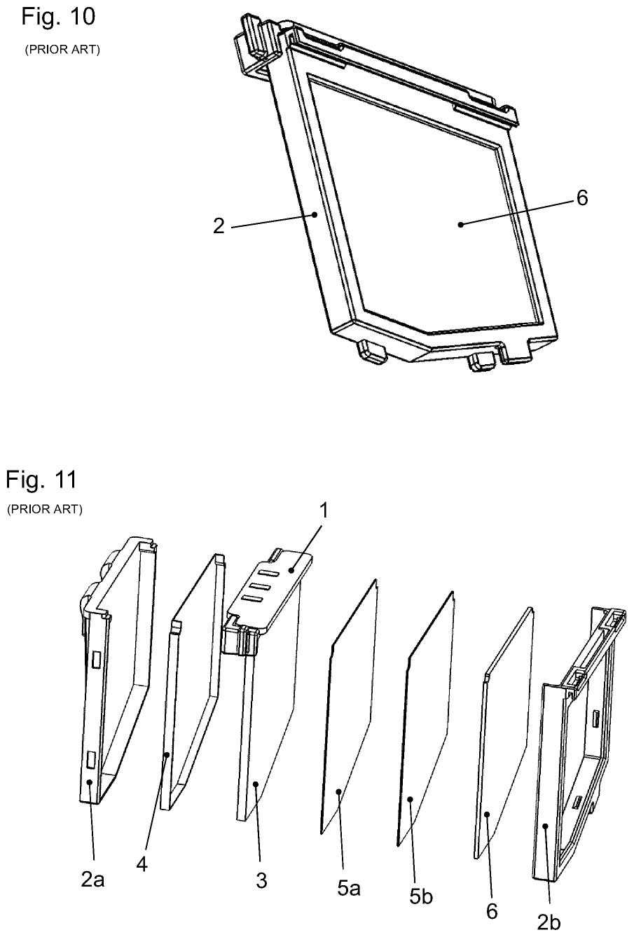

The first main light module 10 further comprises secondary optics comprising a first transparent substrate 16 having an entry surface 17 and an exit surface 18, wherein a structure is provided on each of the entry surface 17 and the exit surface 18 of the first substrate 16. Here, the first substrate 16 has at least one array of irregularly shaped cylindrical lenses, wherein the entry surface 17 of the first substrate 16 has a plurality of differently sized entry facets 19, and wherein the exit surface 18 of the first substrate 16 has a plurality of equally sized exit facets 20 (see FIG. 8 and FIG. 9).

The first substrate 16 is set up to shape light passing through in a vertical direction when the lighting device is installed in the vehicle, wherein the first substrate 16 of the first main light module 10 is set up to produce a gradual vertical light distribution. The light emanating from the first main light module 10 is shaped in a horizontal direction by the additional optical component 13, which causes the light to expand in a horizontal direction when the lighting device is installed in the vehicle.

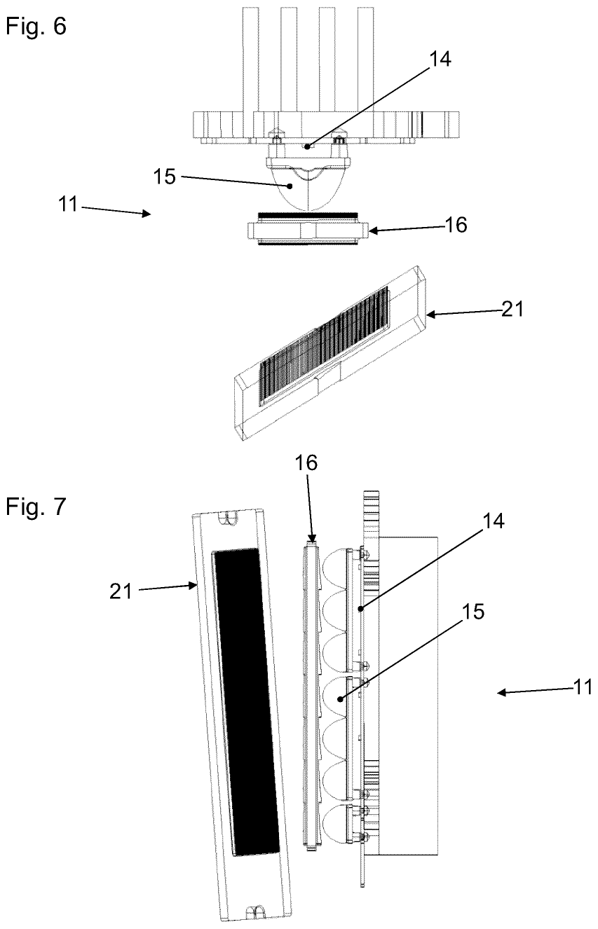

The second main light module 11 is shown in FIG. 6 and FIG. 7. This second main light module 11 is used to generate at least part of a low beam light distribution, wherein the second main light module 11 is used in particular to generate an apron portion of a low beam light distribution.

Like the first main light module 10, the second main light module 11 comprises a plurality of light sources 14 and collimating optics serving as primary optics with a plurality of collimating lenses 15. These light sources 14 and the collimation optics are designed similarly to the first main light module 10.

The second main light module 11 further comprises secondary optics with a first transparent substrate 16 and a second transparent substrate 21, through which the light emanating from the collimating optic can pass in succession. Here, the first substrate 16 has a similar design to that of the first main light module 10, wherein the first substrate 16 of the second main light module 11 is, however, set up in particular to generate a horizontal cut-off line.

A strip-shaped structure formed by cylindrical lenses is provided on the entry surface and/or on the exit surface of the second substrate 21. The cylindrical lenses are arranged side by side in the first direction, wherein the cylindrical axes of the cylindrical lenses extend in the second direction to expand light passing through the strip-shaped structure in the horizontal direction when the lighting device is installed in the vehicle. The final widening of the light emanating from the second main light module 11 to approximately ±40° is achieved by the additional optical component 13.

The signal light module 12 comprises at least one light source not shown and a flat light guide 22 with an entry surface and two exit surfaces. The entry surface is arranged on the lower end face of the light guide 22 in FIG. 1. The front surface in FIG. 1 and the rear surface in FIG. 1 serve as exit surfaces. Here, the rear exit surface in FIG. 1 can be structured at least in sections in order to achieve preferential decoupling of the light moving through the light guide 22 by the front exit surface.

A plurality of light sources arranged next to one another in the transverse direction of the vehicle can be provided, which are designed as light-emitting diodes. The multiple light-emitting diodes can also have different colors, for example to implement a double function or a triple function. For example, light-emitting diodes with red and yellow or white and yellow or white and cyan, or bi-color LEDs or RGB LEDs are possible. The functions can be, for example, a position light, a daytime running light and a direction indicator or a position light, a daytime running light and an autonomous driving function, wherein the autonomous driving function requires a cyan color.

The signal light module 12 further comprises a first and a second optical component 23, 24, which are each designed as a microstructured optical film and/or a microstructured optical disk. In this case, the signal light module 12 is set up so that the light emerging from the at least one exit surface of the flat light guide 22 passes successively through the first and second optical components 23, 24. The first optical component 23 has diffuser optics. The second optical component 24 has at least one array of roof prisms. The array of roof prisms serves as BEF optics.

The signal light module 12 further comprises a third optical component 25, which is designed as an at least partially reflective surface arranged on the side of the flat light guide 22 facing away from the first two optical components 23, 24. The lighting device is set up so that light emitted from the exit surface of the light guide 22 facing away from the first two optical components 23, 24 strikes the reflective surface of the third optical component 25, is reflected back from the latter to the exit surface and at least partially re-enters the light guide 22 before it emerges from the exit surface facing the first two optical components 23, 24.

The lighting device is set up so that the light emitted by the second main light module 11 moves past the signal light module 12 before it strikes the additional optical component 13 (see FIG. 2).

The lighting device is also set up so that light emanating from the first main light module 10 passes through the signal light module 12 before it strikes the additional optical component 13 (see FIG. 1 to FIG. 3). In order to allow the light to pass through the signal light module 12 as unhindered as possible, the optical components 23, 24, 25 of the signal light module 12 each have a recess 26 (see FIG. 1). Furthermore, the structuring of the rear exit surface of the light guide in FIG. 1 is not provided in a portion aligned with the recesses 26 in order to allow the light emanating from the first main light module 10 to pass through.

### LIST OF REFERENCE SIGNS

1 light source
2 housing
2a, 2b housing part
3 light guide
4 reflective film
5a, 5b optical component designed as a micro-optical film
6 cover disk
10 first main light module
11 second main light module
12 signal light module
13 additional optical component
14 light source of the main light module
15 collimating lens of the main light module
16 first transparent substrate of the main light module
17 entry surface of the first substrate
18 exit surface of the first substrate
19 entry facet on the entry surface of the first substrate
20 exit facet on the exit surface of the first substrate
21 second transparent substrate of the second main light module
22 light guide of the signal light module
23 first optical component of the signal light module
24 second optical component of the signal light module
25 third optical component of the signal light module
26 recess in the optical component of the signal light module

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising:
a main light module for generating at least part of a low beam or a high beam, wherein the main light module has a first light source, a primary optic, and a secondary optic, and wherein the main light module is configured such that light emitted by the first light source passes through the primary optic and the secondary optic;
a signal light module for generating at least one signal light function, wherein the signal light module has a second light source, a flat light guide with an entry surface and an exit surface, and an optical component, wherein the optical component is an optical disk or an optical film, wherein the signal light module is configured such that light emitted by the second light source enters the entry surface, emerges from the exit surface, and passes at least partially through the optical component or is reflected by the optical component; and
an additional optical component, the additional optical component being an an optical disk or an optical film that has an entry surface and an exit surface, wherein a structure is provided on the entry surface or the exit surface of the additional optical component, and wherein the additional optical component is arranged in the lighting device such that, during operation of the lighting device, light generated by the main light module and light generated by the signal light module propagates through the additional optical component.

2. The lighting device of claim 1, wherein the structure is strip-shaped and is configured to widen light propagating in a horizontal direction when the lighting device is installed in the motor vehicle.

3. The lighting device of claim 2, wherein the strip-shaped structure includes cylindrical lenses that are arranged next to each other in a first direction which corresponds to the horizontal direction, and wherein the cylindrical lenses define a cylindrical axis in a second direction, the second direction being a vertical direction when the lighting device is installed in the motor vehicle.

4. The lighting device of claim 1, wherein the first light source comprises a plurality of light sources, and wherein the primary optic is a collimating optic with a plurality of collimating lenses, each of which has an entry surface and an exit surface through which light from the plurality of light sources passes in succession.

5. The lighting device of claim 4, wherein the secondary optic of comprises a first transparent substrate having an entry surface and an exit surface, wherein a further structure is provided on the entry surface or on the exit surface of the first transparent substrate to produce a horizontal cut-off line or a gradual vertical light distribution.

6. The lighting device of claim 5, wherein:
the first transparent substrate comprises an array of irregularly shaped cylindrical lenses;
the entry surface of the first transparent substrate comprises differently sized entry facets; and
the exit surface of the first transparent substrate comprises equally sized exit facets.

7. The lighting device of claim 6, wherein:
the secondary optic of comprises a second transparent substrate having an entry surface and an exit surface;
a strip-shaped structure is provided on the entry surface or on the exit surface of the second transparent substrate;
the strip-shaped structure is formed by cylindrical lenses which are arranged next to one another in the first direction and which define cylindrical axes; and
the cylindrical axes of the cylindrical lenses extend in the second direction in order to expand light passing through the strip-shaped structure in the horizontal direction when the lighting device is installed in the vehicle.

8. The lighting device of claim 1, wherein the signal light module comprises a first optical component and a second optical component which are each configured as a microstructured optical film or as a microstructured optical disk, such that light emerging from the at least one exit surface of the flat light guide passes successively through the first and the second optical component.

9. The lighting device of claim 8, wherein the first optical component has diffuser optics, and wherein the second optical component has an array of roof prisms.

10. The lighting device of claim 9, wherein:
the flat light guide has two mutually opposite exit surfaces;
the signal light module includes a third optical component, the third optical component including a reflective surface disposed on a side of the flat light guide facing away from the first and second optical components; and
the lighting device is configured such that light emitted from the exit surface of the light guide facing away from the first and second optical components strikes the reflective surface, is reflected to the exit surface, and re-enters the light guide before it emerges from the exit surface facing the first and second optical components.

11. The lighting device of claim 1, wherein the lighting device is configured such that light emanating from the main light module propagates past the signal light module before impinging the additional optical component.

12. The lighting device of claim 1, wherein the lighting device is configured such that light emanating from the main light module propagates through the signal light module before impinging the additional optical component.

13. The lighting device of claim 12, wherein the optical component of the signal light module has at least one recess or at least one unstructured transparent portion to allow light emanating from the main light module to pass through the optical component.

14. The lighting device of claim 12, wherein the flat light guide of the signal light module is configured to allow light emanating from the main light module to pass through substantially unhindered.

15. The lighting device of claim 1, wherein:
the exit surface of the flat light guide of the signal light module is provided with a structuring; and
the structuring is not provided at a portion of the exit surface in order to allow the light emanating from the at least one main light module to pass through.
